(19) United States
(12) Patent Application Publication
(10) Pub. No.: US 2018/0356779 A1
(43) Pub. Date: Dec. 13, 2018

(54) ENERGY PROCUREMENT MANAGEMENT HAVING DELAYED CHOICE BIAS

(71) Applicant: International Business Machines Corporation, Armonk, NY (US)

(72) Inventors: Harish Bharti, PUNE (IN); Abhay K. Patra, PUNE (IN); Rajesh K. Saxena, MAHARASHTRA (IN)

(21) Appl. No.: 15/619,120

(22) Filed: Jun. 9, 2017

(51) Int. Cl. G05B 19/042

(52) U.S. Cl. CPC G05B 19/042; G05B 2219/2639

(57) ABSTRACT

A method, system and computer program product for an energy distributor to meet a demand/supply gap are disclosed. In an embodiment, the method comprises receiving at a processing system real time data from a series of meters identifying an amount of energy delivered to customers; identifying a demand/supply gap in a distribution of the energy to the customers; and creating a bias toward demand response conservation to meet the demand/supply gap. The processing system employees a decision model, incorporating said bias and using said real time data from said series of meters to determine demand response conservation data, to determine a threshold time to purchase energy to meet the demand/supply gap, therein reducing energy procurement to meet the demand/supply gap by participating at the threshold time for a market call operation. In an embodiment, the bias incorporates a growth rate of demand response adaption.

### BACKGROUND

This invention generally relates to energy procurement management, and more specifically, to determining when an energy distribution utility should make a decision to purchase energy.

In electricity distribution operations, utilities perform long term and short term demand forecasting to plan adequately for the generation of electricity, supply side solutions to address demand for the electricity, and demand response programs to incentivize energy conservation. Often, to meet a short term demand for energy, referred to as an energy gap, utilities make spot or short term energy purchases from spot markets. Often, the utilities predetermine the energy load that can be reduced or eliminated by a demand response program, and develop a short term energy supply or energy purchase program to meet the remaining energy demand.

### SUMMARY

A method, system and computer program product for an energy distributor to meet a demand/supply gap are disclosed. In an embodiment, the method comprises receiving at a processing system real time data from a series of meters identifying an amount of energy delivered to customers; identifying a demand/supply gap in a distribution of the energy to the customers; and creating a bias toward demand response conservation to meet the demand/supply gap. The processing system employs a decision model, incorporating said bias and using said real time data from said series of meters to determine demand response conservation data, to determine a threshold time to purchase energy to meet the demand/supply gap, therein reducing energy procurement to meet the demand/supply gap by participating at the threshold time for a market call operation.

In embodiments, the bias incorporates a growth rate of demand response adaption.

In embodiments, the employing a decision model includes delaying the energy procurement as long as the decision model prefers demand response over an energy purchase program to meet the demand/supply gap.

In embodiments, the employing a decision model includes determining values for defined leading indicators over a first time period, and using the defined leading indicators to construct a regression model to predict the demand/response performance over the second time period.

In embodiments of the invention, the employing a decision model includes employing a decision gradient that helps in a decision optimization by leveraging real time demand response performance data, and the decision gradient represents an intrinsic growth rate of demand response adoption.

Embodiments of the invention optimize the process of determining when an energy distribution utility should decide to purchase energy by infusing a bias for demand response and delaying the energy procurement decision as long as it can be ensured that demand response is preferred over an energy purchase program to fill the energy gap between supply and demand, until the freedom to delay is significantly reduced and thus requires a decision of a block energy purchase in the open market.

Embodiments of the invention use real time demand response performance data and intrinsic growth rate of demand response adoption for the above-described decision optimization.

Embodiments of the invention improve energy efficiency principles and reduce the carbon footprint of utilities by reducing energy purchases by the utilities from the open market.

Embodiments of the invention provide a decision gradient that helps to determine when to purchase energy on the open market by leveraging real time demand response performance data and the intrinsic growth rate of demand response adoption. In embodiments of the invention, this decision gradient simulates the real life decision curve. The gradient is the rate of change, or slope, of the decision curve, and typically increases gradually (choice of demand response operation) and then decreases significantly towards the threshold of limiting capacity. This is because as the limiting capacity is approached, the freedom to wait for a demand response operation to decrease energy demand reduces significantly, and the energy provider is thus forced to make a decision to purchase block energy in the open market.

### BRIEF DESCRIPTION OF THE SEVERAL VIEWS OF THE DRAWINGS

FIG. 1 illustrates an energy distribution system that may be used in or with embodiments of the invention.

FIG. 2 is a flow chart describing an embodiment of the invention.

FIG. 3 illustrates a range of choices for filling an energy gap and a bias for using a demand response to meet that gap.

FIG. 4 shows a timeline for making a decision to purchase energy on an open market.

FIG. 5 depicts a decision gradient that illustrates a bias toward using demand response to delay an open market energy purchase to meet an energy gap.

FIG. 6 is a plot that may be used in a simulation of a model for determining when to select purchasing energy on the open market.

FIG. 7 is an example table that illustrates how embodiments of the invention help to reduce losses.

FIG. 8 is a graph showing the contribution of demand response in the example of FIG. 7.

FIG. 9 is a table that shows losses that can be avoided by delaying the decision to purchase energy on the open market.

FIG. 10 is a pictorial representation of a network of data processing systems in which embodiments of the invention may be implemented.

FIG. 11 shows a block diagram of a data processing system that may be used in the network of FIG. 10.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

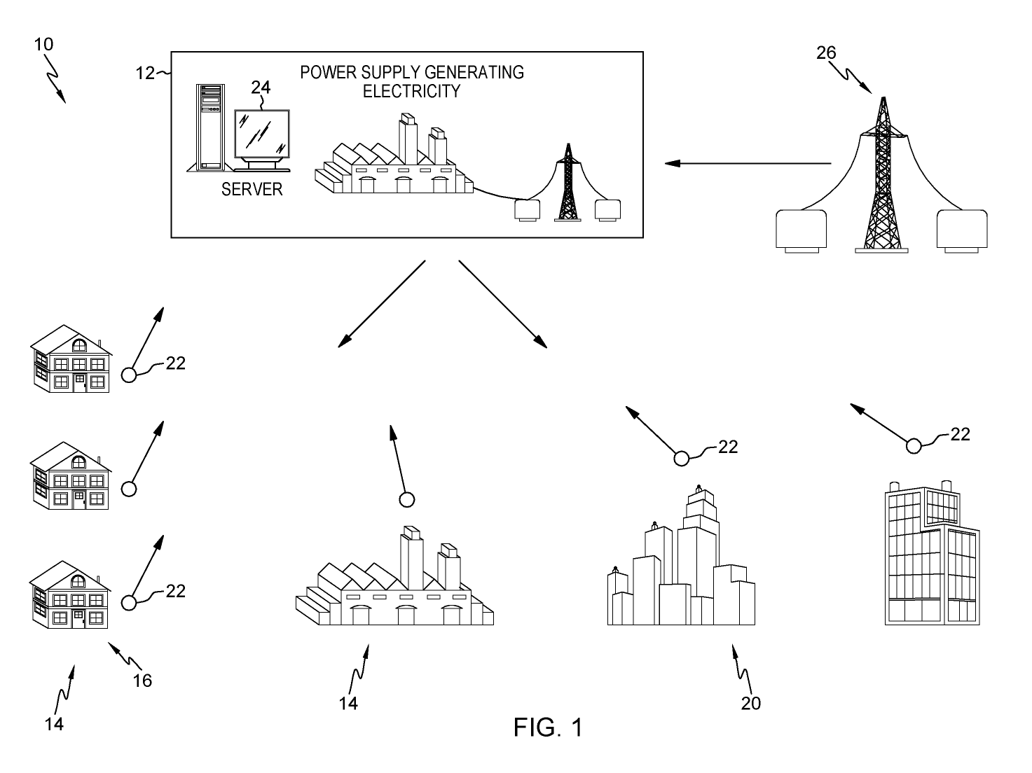

Embodiments of the invention relate to energy procurement management, and more specifically, to determining when an energy distribution utility should make a decision to purchase energy. FIG. 1 illustrates an energy distribution system 10 in accordance with an embodiment of the invention. In this system, an energy distributor 12 supplies energy to customers 14. These customers typically include consumer customers, represented at 16, and commercial customers, represented at 20. Each customer has or is associated with a meter, represented at 22, for metering or measuring the amount of energy delivered to the customer, and real time data from these meters 22 are sent to distributor 12. A processing system 24 receives this data. There are times when the distributor 12 needs to purchase energy on the spot market, represented at 26. Embodiments of the invention receive the real-time data from customers 14 and use that data to determine when to make the decision to purchase energy on the spot market.

As discussed above, in electricity distribution operations, utilities perform long term and short term demand forecasting to plan adequately for the generation of electricity, supply side solutions to address demand for the electricity, and demand response programs to incentivize energy conservation. Often, to meet a short term demand for energy, referred to as an energy gap, utilities make spot or short term energy purchases from spot markets. Often, the utilities predetermine the energy load that can be reduced or eliminated by a demand response program, and develop a short term energy supply or energy purchase program to meet the remaining energy demand.

Embodiments of the invention enable utilities to maximize the effects of demand response and to delay the energy purchase decision, thereby reducing the amount of energy that ultimately needs to be purchased. This not only ensures reducing the grid operation cost for distribution utilities but also ensures an improved energy efficiency effort by reducing the carbon foot print of the utility.

Demand response (DR) refers to mechanisms used to encourage/induce utility consumers to curtail or shift their individual demand in order to reduce aggregate utility demand during particular time periods. For example, electric utilities employ demand response programs to reduce peak demand for electricity. Demand response programs typically offer customers incentives for agreeing to reduce their demand during certain time periods.

Even when effective demand response programs are used, there are times when a utility can foresee that in the near future, the utility will need to purchase energy on the open market in order to meet anticipated demand. Embodiments of the invention allow the utilities to delay the time at which they need to make that decision to buy additional energy. This reduces the amount of energy the utility needs to buy, and this, in turn, reduces the cost and the carbon footprint of the purchased energy.

Generally, this is done by developing a gradient as a continuous function for the twin-decision modeling, i.e., how much of the energy gap will be met by the demand response participation program, and how much needs to be met by the outright block purchase of energy from the available suppliers.

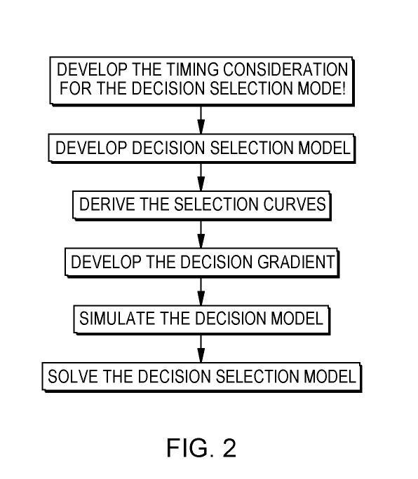

FIG. 2 is a flowchart 10 listing several aspects of embodiments of the invention. These aspects include developing the timing consideration for the decision selection model 12, developing the decision selection model 14, deriving the selection curves 16, developing the decision gradient 20, simulating the decision model 22, and solving that decision selection model 24. These aspects are discussed in more detail below.

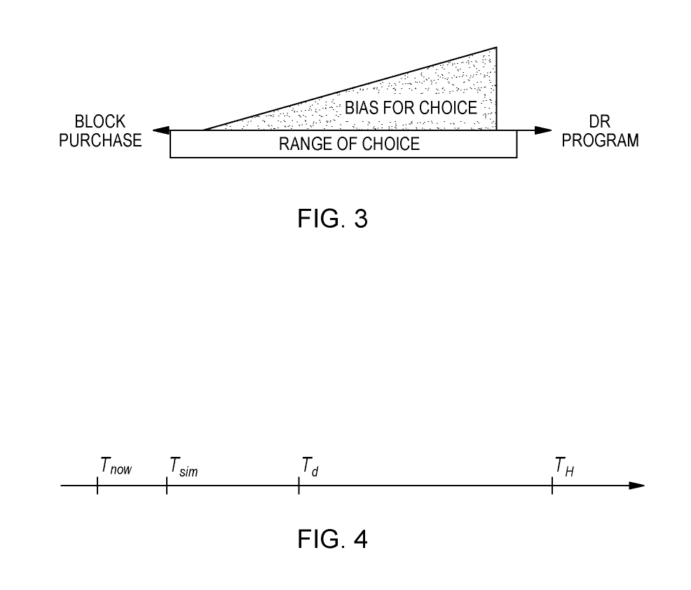

The energy utility grid has a spectrum of choices which can be defined as follows: How much of the energy gap will be met by the demand response participation program, and how much of the energy gap will be met by the outright block purchase from the available suppliers. This decision is graphically depicted in FIG. 3.

In this depiction, “block purchase” means filing the energy demand by performing open market operations, and “DR program” refers to repressing demand through incentives to minimize the energy gap.

The decision is biased more towards the DR program, and in embodiments of the invention, the bias is retained in the decision model.

This can be done by delaying the block purchase decision to a point where it can be ensured that the energy gap is filled by reduced energy demand—that is, by delaying the block purchase decision as long as it can be ensured that the energy gap is filled by reduced energy demand.

In embodiments of the invention, the two choices and the bias in the decision making process are defined. Embodiments of the invention create a strong bias towards using or relying on the demand response program to repress the energy demand, as compared to the energy purchase program.

Developing Timing Considerations

Delaying this decision has a number of benefits. FIG. 4 shows a timeline identifying a number of time points that may be taken into consideration in an analysis of delaying the decision to purchase energy on the open market.

A sequential approach to analysis is cumbersome if up-to-date information is desired about the decision as conditions change over the interval T_{now} to T_{d}. A simulation model would need to be repeatedly parameterized and executed. An alternative is to make multiple runs of the simulation model at the beginning using a range of parameter values.

Various indicators, referred to as “leading indicators,” are calculated over the course of each sample path, up to simulated time T_{d}. Then at any time Tᵢ between T_{now} and T_{d}, a regression model can be constructed to predict performance over the interval [T_{d}, T_{H}] based on the values of the leading indicators over the interval [T_{now}, Tᵢ].

By calculating the actual values of the leading indicators from the real-world data, the expected performance can be predicted, conditional on the environment up to time T₁.

The decision making process described herein is used to benefit by simulating the expected mix between demand response and energy purchase programs. The utilities would like to wait as long as they can before making a decision to buy energy on the open market to ensure that they are preferring demand response instead of an energy purchase program.

Developing the Selection Model

Deriving the Selection Curve

In embodiments of the invention, the selection curve is created from the data at T_{now} and refined until Tₛᵢₘ to ensure that the correct representation of the realtime data from the demand response program is used, and to ensure that the decision to make a block energy purchase can be delayed to represent the bias. Once the demand repression has been simulated and has become clear, the utility can ensure that the rest of the demand is fulfilled by the block purchase program.

In the discussion below, the following variables are used:

λ represent the demand response decision gradient, with its value signifying how much of the energy demand is fulfilled by demand response;
Υ represent the energy deficit;
α is the gradient, or amount, of shift of energy from block purchase to demand response;
β represents the intrinsic growth rate of demand response adoption;
t represents the reduction in energy use due to demand response (“demand response”) divided by an amount of energy that needs to be obtained by a block purchase (“block purchase”)—that is,
t=demand response/block purchase.
λ(t) can be modeled by logistic function as follows:

$$λ ( t ) = γ \cdot ( \frac{{e}^{α + β t}}{1 + {e}^{α + β t}} ) \qquad Equation ( 1 )$$

The logistic transformation helps develop all the characteristics of the decision making process—{two choices, a bias for two choice, delay in decision, limiting capacity}—making it very well suited for the decision model.

Developing the Decision Gradient

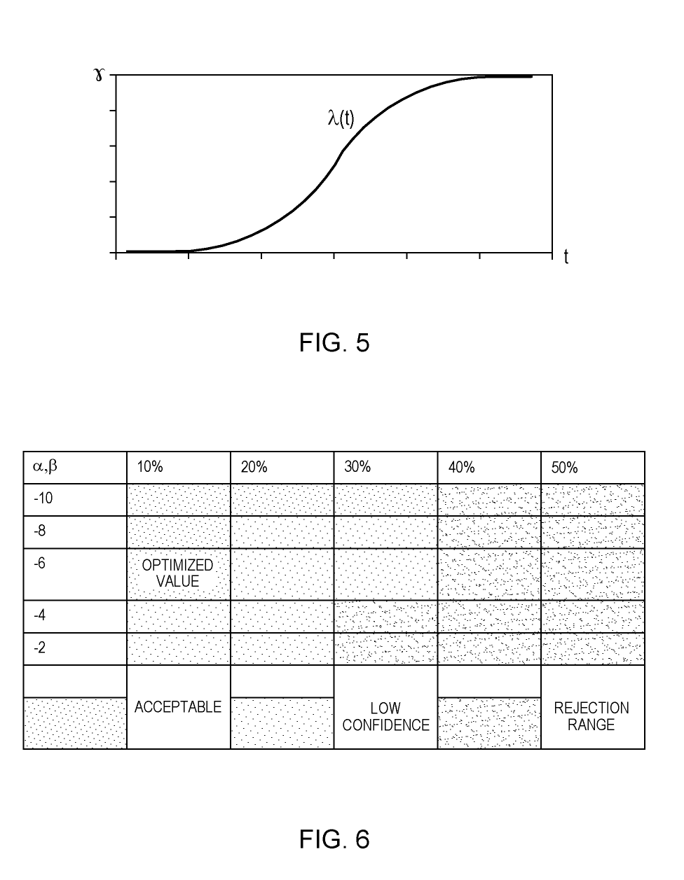

λ(t) is graphically represented in FIG. 5. The rate at which the slope of the curve increases initially is mirrored by the rate at which the slope decreases as the curve approaches the limiting capacity of Υ. This is because as the limiting capacity is approached, the freedom to wait reduces significantly, and the energy utility is thus forced to take a decision of block energy purchase in the open market.

Note that α shifts the function λ(t) from left to right. A higher value of α signifies a bias of choice that is retained in the decision process.

β is the intrinsic growth rate of demand response adoption, synonymous to the demand response program adoption. The higher the value of β, the greater is the adoption of the demand response by the consumer.

The logistic function is designed to adapt to the decision making model in terms of choices, biases and timing considerations.

Solving for the Selection Model

In the Equation (1), “t” is modeled as detailed above, but the unknowns are α and β.

At various times Ti in the range [Tₛᵢₘ, T_{d}], the parameters α and β are estimated from the following: realtime data for the demand response program, and availability of the suppliers in the open market for block purchase transactions.

As an example, suppose that there were n options to purchase energy on the open market during the interval [T_{now}, Ti]. Let t_{now}=T₀ and let t₁, . . . , tₙ be the times at which these options are available during the simulation between T0 and Ti.

The demand response decision gradient has the form:

$$From Equation ( 1 )$$

$$λ ( t ) = γ \cdot ( \frac{{e}^{α + β t}}{1 + {e}^{α + β t}} )$$

Where α and β are values that are to be estimated.

The integrator decision rate function is:

$$Λ ( t ) = {\int }_{0}^{t} λ ( a ) \cdot da = \frac{γ}{β} ln ( \frac{{e}^{α + β t}}{1 + {e}^{α}} ) \qquad Equation ( 3 )$$

A random variable Xᵢ is defined as follows:

$$\begin{matrix}{X}_{i} = Λ ( {t}_{i} ) - Λ ( {t}_{i - 1} ) for I = 1 … n & Equation ( 4 ) \\ {X}_{i} = \frac{γ}{β} ln ( \frac{{e}^{α + β {t}_{i}}}{1 + {e}^{α + β {t}_{i - 1}}} ) & Equation ( 5 )\end{matrix}$$

The Xᵢ's are exponentially distributed with a mean of one.

Moment estimators \hat{α} and \hat{β} are obtained by solving the equations for α and β.

$$\begin{matrix}1 = \frac{1}{n} {\sum }_{i = 1}^{n} {X}_{i} = \frac{1}{n} {\sum }_{i = 1}^{n} [ \frac{γ}{β} ln ( \frac{{e}^{α + β {t}_{i}}}{1 + {e}^{α + β {t}_{i - 1}}} ) ] & Equation ( 6 ) \\ 2 = \frac{1}{n} {\sum }_{i = 1}^{n} {X}_{i}^{2} = \frac{1}{n} {\sum }_{i = 1}^{n} {[ \frac{γ}{β} ln ( \frac{{e}^{α + β {t}_{i}}}{1 + {e}^{α + β {t}_{i - 1}}} ) ]}^{2} & Equation ( 7 )\end{matrix}$$

The solution may be approximated using, as an example, the Gauss-Newton method.

Solving for tᵢ, α and β and substituting for these terms in Equation (1) gives the exact value of how much of the energy gap will be fulfilled by demand response.

$$\begin{matrix}\begin{matrix}λ ( {T}_{i} ) = Energy from demand response program = \\ = γ \cdot ( \frac{{e}^{α + β {T}_{i}}}{1 + {e}^{α + β {T}_{i}}} )\end{matrix} & Equation ( 8 ) \\ \begin{matrix}{λ}^{A} ( {T}_{i} ) = Energy from energy purchase program = \\ = γ \cdot - λ ( {T}_{i} )\end{matrix} & Equation ( 9 )\end{matrix}$$

The selection model accurately defines, based on the realtime data, how much energy should be purchased in the open market (λ^{A}(Tᵢ)) and how much energy will be managed by the energy demand response program (λ(T₂) to fill the energy gap.

Simulation Assistance for the Selection Model

The first step of the leading indicators methodology is to generate sample paths for the regression model. For each study, simulation runs are planned, drawing values for α and β.

Regression models are then constructed for each timepoint Ti, i=1, 2, 3, . . . , to predict the difference in two choices over the interval [T_{d}, T_{H}].

Finally, at times Ti, i=1, 2, 3, . . . , the regression models are used to make the purchase decisions using estimators \hat{α} and \hat{β} (based on the actual data up to time Tᵢ) for α and β.

A representative plot is shown in FIG. 6.

This way, the correct values of α and β can be identified for a given Υ, and these correct values are validated by the moment estimators \hat{α} and \hat{β}.

As an example, consider the case of Open Grid, Ltd which has an anticipated shortfall (energy gap) of 550 MW. Open Grid, Ltd has significant demand response (DR) operations in place which has attracted a community of approximately 18,000 households and 600 industrial outfits in cooperative lease buyback options offered under the DR operations. It is observed that the household cooperators can garner 400 MW of DR operations savings under peak loads while industrial outfits have a joint buyback of 175 MW capacity.

In this example, it is a cold winter night and the energy demands of most of the public outfits are expected to peak in the next three hours. The DR operations could rely on the provided data, creating a possible savings of 575 MW, which can meet the projected energy shortfall of 550 MW. However, it is a difficult decision to rely solely on these possible energy savings, given the conditions.

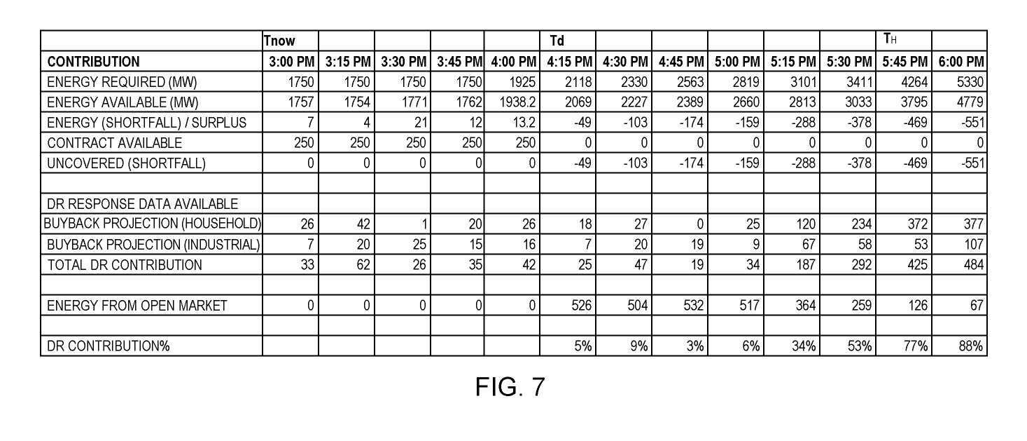

FIG. 7 is a representative working of this example, which shows how the simulation might help reduce the losses by the energy distribution utility.

In the table of FIG. 7, “DR Contribution %” is an intrinsic adoption rate for the DR process and is represented by λ(T).

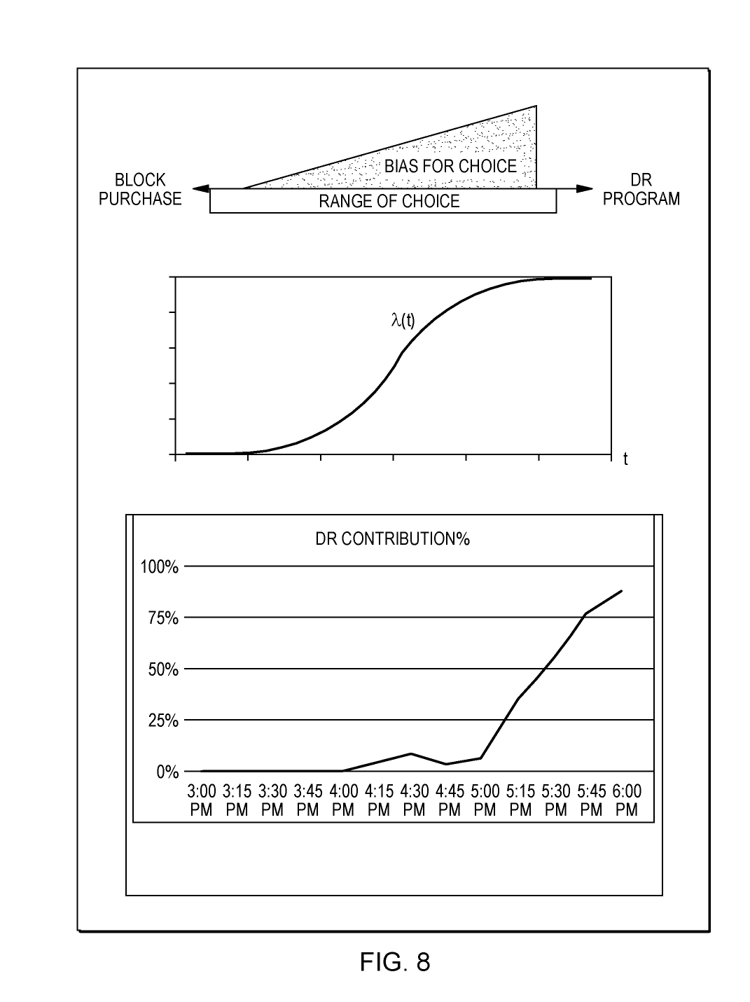

With reference to FIG. 8, the bias and the gradient are what create the logistic transformation to ensure that λ(t) is following the curve received from the simulation.

In most cases today, a new call option is secured at the expiry of the previous hedging contract (in the above example, and as shown in the table of FIG. 7, at 4:15 pm), thus securing 525 MW from the open market operations to cover the existing shortfall for 49 MW, keeping in mind that only 25 MW is known to be received from DR operations and the remaining exposure of 525 MW (at 6 pm) will be hedged in the provision. It is a substantial over-provisioning by ten times for the current shortfall and, more importantly, a wasted opportunity.

If the simulation was between T_{now} and T_{H}, it would be observed that the gradient would take the sigmoid curve and would, to a good extent, ensure the bias towards DR operations.

With the following discussion,

$$λ ( t ) = γ \cdot ( \frac{{e}^{α + β t}}{1 + {e}^{α + β t}} ) ,$$

is the time gradient. β is the DR Contribution %, as given in the last row of the simulation table of FIG. 8.

If the simulations from 4:00 pm to 6:00 pm are observed, then as the procurement time point is delayed over intervals and DR Contribution % increases versus the energy shortfall, the amount of energy that needs to be procured decreases. In this example, the amount of energy procured is the cumulative amount procured until the time of the decision (e.g., from 4 pm till 6 pm). It is not just the energy procured at 6 pm.

α and β need to be computed to get the accurate moments of choices. These can be obtained as follows:

$$λ ( {T}_{i} ) = Energy from demand response program == γ \cdot ( \frac{{e}^{α + β {T}_{i}}}{1 + {e}^{α + β {T}_{i}}} )$$

$${λ}^{A} ( {T}_{i} ) = Energy from energy purchase program == γ - λ ( {T}_{i} )$$

From computation, at 6 pm,
γ=550,
λ(Tᵢ)=484, and
λ^{A}(Tᵢ)=67

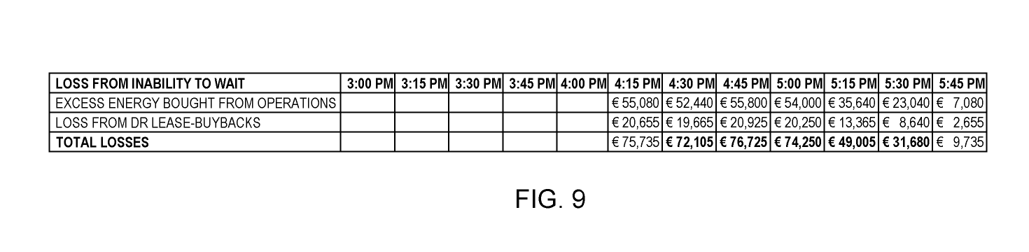

The table of FIG. 9 illustrates the loss that would be incurred by an inability to postpone the decision to purchase energy in the open market. The total savings can be inferred as the losses avoided, as energy cannot be stored. Thus, delaying the decision from 4:15 pm to 5:45 pm can accumulate a savings of € 66,000.

Aspects of the invention may be carried out on a computer system or network of computer systems. The computer system or systems may be used to receive and process data or signals from various sensors, detectors, meters, and data bases, and the computer system or systems may be o receive input from and provide output to various users.

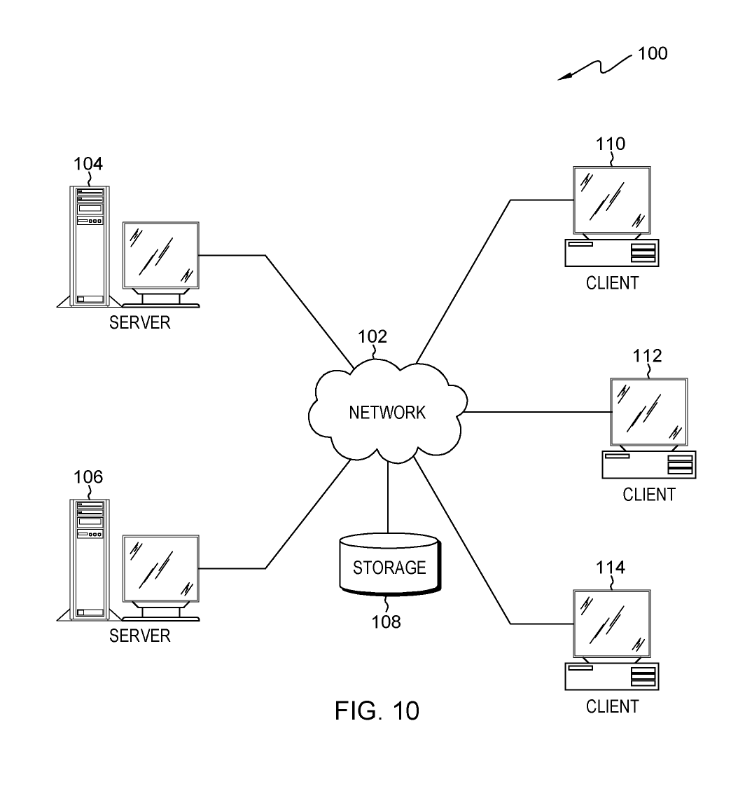

FIG. 10 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides information, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 10 is intended as an example, and not as an architectural limitation for the different illustrative embodiments.

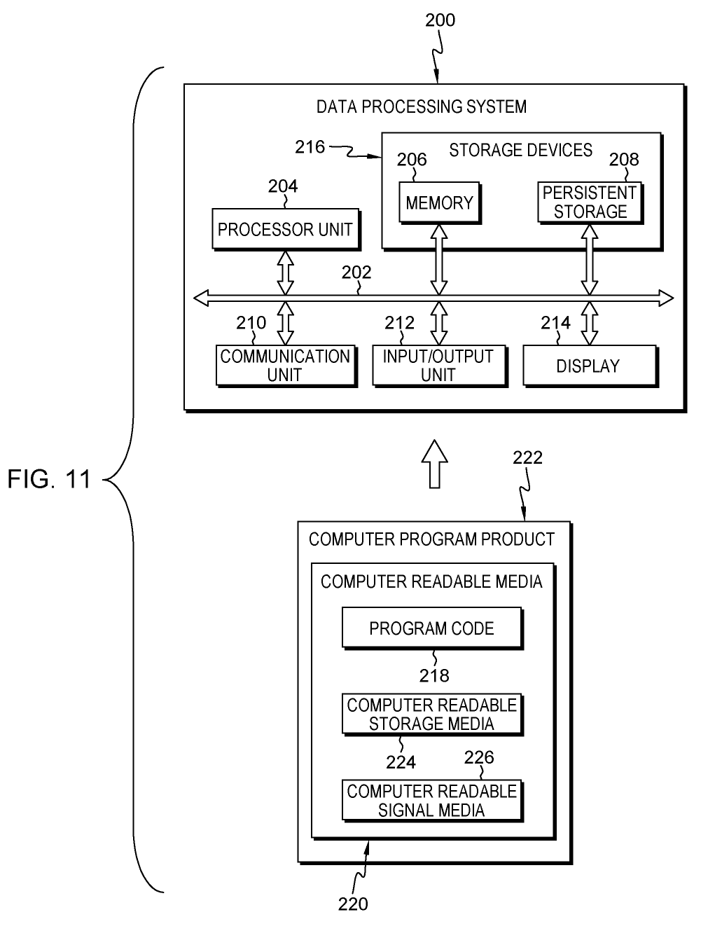

FIG. 11 depicts a diagram of a data processing system in accordance with an illustrative embodiment. Data processing system 200 is an example of a computer, such as server 104 or client 110 in FIG. 10, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 11 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Those of ordinary skill in the art will appreciate that the architecture and hardware depicted in FIGS. 10 and 11 may vary.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method for an energy distributor to meet a demand/supply gap, comprising:
receiving at a processing system real time data from a series of meters identifying an amount of energy delivered to customers;
identifying a demand/supply gap in a distribution of the energy to the customers;
creating a bias toward demand response conservation to meet the demand/supply gap; and
the processing system employing a decision model, incorporating said bias and using said real time data from said series of meters to determine demand response conservation data, to determine a threshold time to purchase energy to meet the demand/supply gap, therein reducing energy procurement to meet the demand/supply gap by participating at the threshold time for a market call operation.

2. The method according to claim 1, wherein the bias incorporates a growth rate of demand response adaption.

3. The method according to claim 2, wherein the employing a decision model includes delaying the energy procurement as long as the decision model prefers demand response over an energy purchase program to meet the demand/supply gap.

4. The method according to claim 3, wherein the bias is created in the decision model in such a way that the decision model waits until the threshold time to make an energy purchase.

5. The method according to claim 1, wherein the employing a decision model includes:
determining values for defined leading indicators over a first time period; and
using the defined leading indicators to predict a demand/response performance over a second time period.

6. The method according to claim 5, wherein the using the defined leading indicators to predict a demand response performance includes using the defined leading indicators to construct a regression model to predict the demand/response performance over the second time period.

7. The method according to claim 5, wherein the determining values for defined leading indicators includes using the real time data to determine the values for the defined leading indicators.

8. The method according to claim 1, further comprising employing a decision gradient that helps in a decision optimization by leveraging real time demand response performance data.

9. The method according to claim 8, wherein the decision gradient represents an intrinsic growth rate of demand response adoption.

10. The method according to claim 9, wherein:
the decision gradient simulates a real life decision curve.
the decision gradient is a rate at which a slope of the decision curve increases gradually; and
the decision gradient deteriorates significantly toward a threshold of limiting capacity.

11. A system for an energy distributor to meet a demand/supply gap, comprising:
a computer system comprising a memory for storing data, and one or more hardware processor units connected to the memory for transmitting data to and receiving data from the memory, the one or more hardware processor units configured for:
receiving real time data from a series of meters identifying an amount of energy delivered to customers;
identifying a demand/supply gap in a distribution of the energy to the customers;
creating a bias toward demand response conservation to meet the demand/supply gap; and
employing a decision model, incorporating said bias and using said real time data from said series of meters to determine demand response conservation data, to determine a threshold time to purchase energy to meet the demand/supply gap, therein reducing energy procurement to meet the demand/supply gap by participating at the threshold time for a market call operation.

12. The system according to claim 11, wherein the bias incorporates a growth rate of demand response adaption.

13. The system according to claim 12, wherein the employing a decision model includes delaying the energy procurement as long as the decision model prefers demand response over an energy purchase program to meet the demand/supply gap.

14. The system according to claim 11, wherein the employing a decision model includes:
determining values for defined leading indicators over a first time period; and
using the defined leading indicators to construct a regression model to predict the demand/response performance over the second time period.

15. The system according to claim 11, wherein:
the employing a decision model includes employing a decision gradient that helps in a decision optimization by leveraging real time demand response performance data; and
the decision gradient represents an intrinsic growth rate of demand response adoption.

16. A computer program product for an energy distributor to meet a demand/supply gap, the computer program product comprising:
a computer readable storage medium having program instructions embodied therein, the program instructions executable by a computer to cause the computer to perform the method of:
receiving real time data from a series of meters identifying an amount of energy delivered to customers;
identifying a demand/supply gap in a distribution of the energy to the customers;
creating a bias toward demand response conservation to meet the demand/supply gap; and
employing a decision model, incorporating said bias and using said real time data from said series of meters to determine demand response conservation data, to determine a threshold time to purchase energy to meet the demand/supply gap, therein reducing energy procurement to meet the demand/supply gap by participating at the threshold time for a market call operation.

17. The computer program product according to claim 16, wherein the bias incorporates a growth rate of demand response adaption.

18. The computer program product according to claim 17, wherein the employing a decision model includes delaying the energy procurement as long as the decision model prefers demand response over an energy purchase program to meet the demand/supply gap.

19. The computer program product according to claim 16, wherein the employing a decision model includes:
determining values for defined leading indicators over a first time period; and
using the defined leading indicators to construct a regression model to predict the demand/response performance over the second time period.

20. The computer program product according to claim 16, wherein:
the employing a decision model includes employing a decision gradient that helps in a decision optimization by leveraging real time demand response performance data; and
the decision gradient represents an intrinsic growth rate of demand response adoption.
